(19) United States
(12) Patent Application Publication
(10) Pub. No.: US 2025/0222734 A1
(43) Pub. Date: Jul. 10, 2025

(54) VEHICLE HEIGHT CONTROL SYSTEM

(71) Applicant: TOYOTA JIDOSHA KABUSHIKI KAISHA, Aichi-ken (JP)

(72) Inventors: Satoshi TAKATO, Nagoya-shi (JP); Hironori KANASAKI, Okazaki-shi (JP)

(21) Appl. No.: 19/001,552

(22) Filed: Dec. 26, 2024

(30) Foreign Application Priority Data
Jan. 9, 2024 (JP) 2024-001312

(51) Int. Cl. B60G 17/017

(52) U.S. Cl. CPC B60G 17/017; B60G 2202/152; B60G 2400/252; B60G 2400/952; B60G 2400/96; B60G 2800/203; B60G 2800/914

(57) ABSTRACT

The vehicle height control system comprises: a controller configured to control a vehicle height; a back door open/close detector configured to detect opening and closing of a back door of a vehicle; and a user detector configured to detect a user outside the vehicle, wherein the controller is configured to: receive information from the back door open/close detector and the user detector, and control the vehicle height when the back door is opened and the user is in a vicinity of the vehicle.

### CROSS REFERENCE TO RELATED APPLICATION

This application claims priority to Japanese Patent Application No. 2024-001312 filed on Jan. 9, 2024, which is incorporated herein by reference in its entirety including the specification, claims, drawings, and abstract.

### TECHNICAL FIELD

This specification discloses a vehicle height control system.

### BACKGROUND

Conventionally, there has been known a vehicle height control device in which an actuator is disposed between a wheel and a vehicle body to control a vehicle height to a desired height. Further, there is a vehicle having a back door at a rear portion thereof. When the height of the terminal end of the back door when the back door is opened is defined as an “open position”, the open position changes depending on the height of the vehicle when the back door is opened. In such a vehicle, if the open position of the back door is too low, the back door may interfere with loading and unloading of luggage, and if the open position of the back door is too high, it may be difficult for a hand to reach the back door.

Patent Document 1 discloses an automobile with a back door that controls to change the height of the back door. The vehicle with a back door includes a vehicle height control device that controls a vehicle height, and an open position control device that controls an open position of the back door in response to the vehicle height control by the vehicle height control device. According to this configuration, when the height position of the back door with respect to the road surface is changed due to the change of the vehicle height by the vehicle height control, the open position of the back door can be changed. As a result, the inconvenience caused by the vehicle height can be reduced.

Meanwhile, when the user takes in and takes out the load, if the load platform is high, it may be inconvenient to take in and take out the load. In Patent Document 1, the open position of the back door is controlled according to the vehicle height, but there is no idea of controlling the vehicle height in consideration of taking in and out the load. Therefore, in the present specification, a vehicle height control system that controls the vehicle height so that the load can be easily taken in and out is realized.

### CITATION LIST

PATENT DOCUMENT 1: JP.2008-037395 A

### SUMMARY

A vehicle height control system disclosed in this specification includes: a controller configured to control a vehicle height; a back door open/close detector configured to detect opening and closing of a back door of a vehicle; and a user detector configured to detect a user outside the vehicle, wherein the controller is configured to: receive information from the back door open/close detector and the user detector; and control the vehicle height when the back door is opened and the user is in a vicinity of the vehicle.

According to the above configuration, regardless of the operation of the user, the opening and closing of the back door of the vehicle and the presence or absence of the user outside the vehicle are detected, and the vehicle height is controlled in accordance with the detection result. By adjusting the vehicle height, it is possible to reduce the burden on the user on taking in and out the luggage.

The controller may be configured to return the vehicle height to an initial position when the controller determines that the back door is closed from an open state based on the information received from the back door open/close detector.

According to the above configuration, the vehicle height can be returned to the initial position in response to the closing operation of the back door.

Further, the controller may be configured to receive registration of user information, and the controller may be configured to, when a registered user is detected by the user detector, determine the vehicle height corresponding to the registered user based on the user information, and adjust the vehicle height according to a determination result.

According to the above configuration, the value of the vehicle height after the change is not uniformly defined as a specific value, but can be set in accordance with a user registered in advance. As a result, the vehicle height can be set to a height more suitable for the preference of the user.

According to the vehicle height control system disclosed in the present specification, since the vehicle height is adjusted, it is possible to reduce the load of taking in and out the package.

### BRIEF DESCRIPTION OF DRAWINGS

Embodiment(s) of the present disclosure will be described based on the following figures, wherein:

FIG. 1 is a block diagram showing a configuration of a vehicle height control system; and

FIG. 2 is a flowchart illustrating an example of processing performed by the vehicle height control system.

### DESCRIPTION OF EMBODIMENT

Hereinafter, a vehicle height control system will be described with reference to the drawings. Hereinafter, a vehicle height control system mounted on a vehicle will be described as an example. However, for example, a part of the vehicle height control system may be installed in a vehicle management center or the like outside the vehicle, or may be built on the cloud.

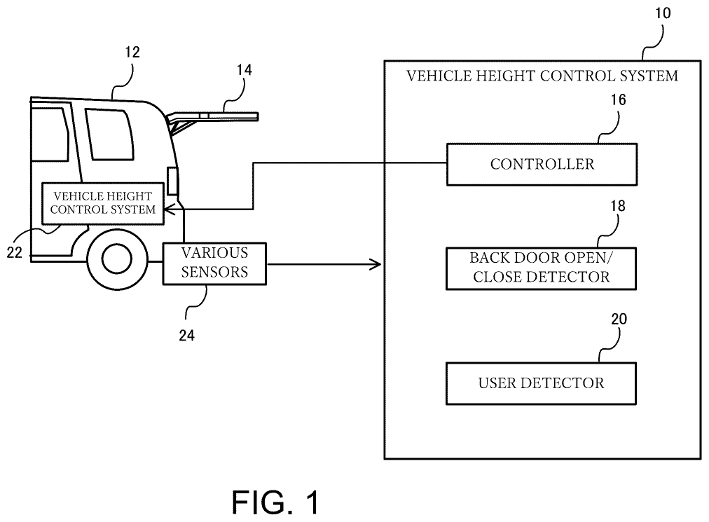

FIG. 1 is a block diagram showing a configuration of a vehicle height control system; The vehicle height control system 10 is a system that controls the vehicle height of the vehicle 12. A back door 14 is installed at a rear portion of the vehicle 12. The back door 14 is a power back door that is opened and closed by an actuator. In addition, the vehicle 12 according to the present example is equipped with an air suspension system that adjusts the height of the vehicle body by an air spring (i.e., a suspension) to reduce an impact during traveling due to unevenness or the like on a road surface.

As shown in FIG. 1, the vehicle height control system 10 includes a controller 16, a back door open/close detector 18, and a user detector 20. The controller 16 is an electronic control unit including at least a CPU that performs various arithmetic processing and a memory that stores control programs and data. The controller 16 controls a communication unit (not shown) provided outside or in the vehicle height control system 10 to transmit and receive data to and from various systems provided in the vehicle height control system 10 or the vehicle 12. Further, the controller 16 controls the vehicle height and controls the operation of each unit mounted on the vehicle 12. As one example, the controller 16 controls the operation of the vehicle height adjusting unit 22 mounted on the vehicle 12. Under the control of the controller 16, the vehicle height adjusting unit 22 controls the air suspension system to adjust the vehicle height of the vehicle 12.

The back door open/close detector 18 detects opening/closing of the back door 14. The user detector 20 detects a user outside the vehicle. The vehicle 12 is provided with various sensors 24, and signals detected by the various sensors 24 are transmitted to the vehicle height control system 10. The back door open/close detector 18 and the user detector 20 each receive information transmitted from various sensors 24. For example, the information detected by the user detector 20 is information of a signal from an electronic key possessed by a user registered in advance as a user of the vehicle 12. The electronic key is a known electronic key that wirelessly communicates with the vehicle height control system 10, and is, for example, a smart key or a smartphone. When the electronic key is outside the vehicle 12 and within a preset range, the user detector 20 detects that the user is outside the vehicle 12 and around the vehicle.

The controller 16 receives information from the back door open/close detector 18 and the user detector 20. When the back door 14 is opened and it is determined that the registered user is around the vehicle 12, the controller 16 operates the vehicle height adjusting unit 22 to control the vehicle height.

In addition, the memory included in the controller 16 may hold information of the user registered as the user of the vehicle 12 in advance. For example, when the height of the registered user is low, it may be inconvenient to load and unload the package from the loading platform. Therefore, the controller 16 causes the memory to hold information “The appropriate vehicle height for the user is a height that is several steps down from the initial position.” as the registered user information. By using the information of the user registered in advance in this manner, when the registered user is detected by the user detector 20, the controller 16 can determine an appropriate vehicle height and adjust the vehicle height to an appropriate vehicle height for each user (in other words, a vehicle height suitable for each user's preference).

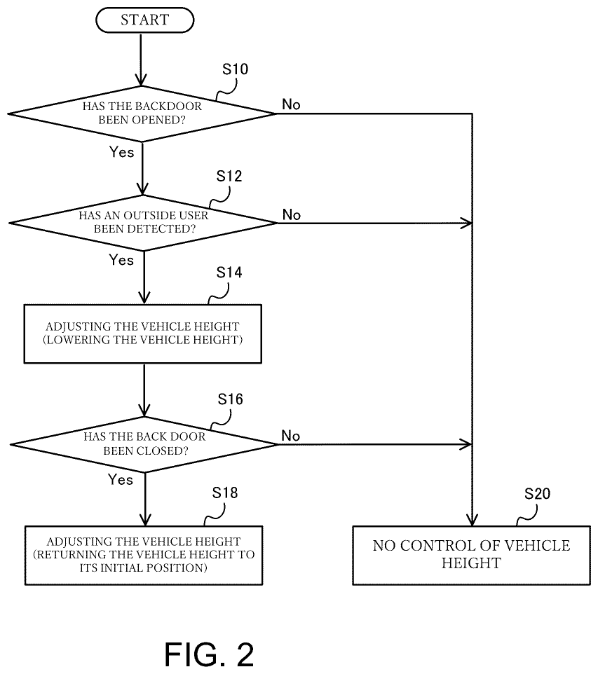

Next, the control of the vehicle height control system 10 performed by the controller 16 will be further described with reference to FIG. 2. FIG. 2 is a flowchart illustrating an example of processing performed by the vehicle height control system 10. In the vehicle height control system 10, for example, the vehicle height is not adjusted using a user's operation as a trigger. Alternatively or additionally, the vehicle height control system 10 determines when control of the vehicle height is required and automatically adjusts the vehicle height. In this example, a series of processes is executed using the opening operation of the back door 14 as a trigger.

First, the controller 16 determines whether or not the back door 14 is opened based on the information received from the back door open/close detector 18 (S10). When the back door 14 is not opened (No in S10), the controller 16 does not perform the control related to the vehicle height control (S20). On the other hand, when the back door 14 is opened (Yes in S10), the process proceeds to step S12. Subsequently, the controller 16 determines whether there is a user registered in advance outside the vehicle based on the information received from the user detector 20 (S12). When the user is not detected outside the vehicle (No in S12), the controller 16 does not perform the control related to the vehicle height adjustment (S20). On the other hand, when the user outside the vehicle is detected (Yes in S12), the controller 16 operates the vehicle height adjusting unit 22 to adjust the vehicle height of the vehicle 12 (S14). Here, the controller 16 lowers the vehicle height so that the user can easily load luggage. Next, the controller 16 determines whether or not the back door 14 is closed based on the information received from the back door open/close detector 18 (S16). When the back door 14 is not closed (No in S16), the controller 16 does not perform control related to vehicle height adjustment (S20). On the other hand, when the back door 14 is closed (Yes in S16), the controller 16 operates the vehicle height adjusting unit 22 to adjust the vehicle height of the vehicle 12 (S18). Specifically, when the back door 14 is closed, it can be determined that the load loading/unloading operation is completed, and thus the controller 16 returns the vehicle height to the initial position.

Through the above-described series of processes, the opening and closing of the back door 14 and whether or not the user is outside the vehicle are detected, and the vehicle height is controlled according to the detection result, regardless of the user's operation on the vehicle height. By adjusting the vehicle height, it is possible to reduce the burden on the user on taking in and out the luggage. Further, in response to the closing operation of the back door 14, it is possible to return to the initial position from a state in which the vehicle height has been lowered or raised. As a result, when the user completes taking in and out the package and causes the vehicle 12 to travel, it is possible to avoid a situation in which the vehicle height is too low or too high to travel.

In the vehicle height control system disclosed in the present specification, the controller may receive information from the back door opening/closing detector and the user detector and control the vehicle height when the back door is opened and the user is in the vicinity of the vehicle. Therefore, other configurations may be changed as appropriate. For example, in the vehicle height control system disclosed in the present specification, the type of the back door is not particularly limited as long as the vehicle height can be adjusted. The back door 14 of the vehicle 12 according to the embodiment is a flip-up type back door, but is not limited thereto, and may be a sideways opening type back door or a tourist opening type back door.

Further, for example, the vehicle height control system may estimate that the user unloads the luggage from the luggage compartment when the back door is opened after the user unloads the vehicle. In addition, the vehicle height control system may estimate that the user loads the luggage in the luggage compartment when the user comes from the outside (in other words, when the vehicle is not traveling). The controller may adjust whether to increase or decrease the vehicle height based on the estimation result.

### REFERENCE SIGNS LIST

10 vehicle height control system, 12 vehicle, 14 back door, 16 controller, 18 back door open/close detector, 20 user detector, 22 vehicle height adjusting unit, 24 various sensors.

1. A vehicle height control system comprising:
a controller configured to control a vehicle height;
a back door open/close detector configured to detect opening and closing of a back door of a vehicle; and
a user detector configured to detect a user outside the vehicle,
wherein the controller is configured to:
receive information from the back door open/close detector and the user detector; and
control the vehicle height when the back door is opened and the user is in a vicinity of the vehicle.

2. The vehicle height control system according to claim 1, wherein
the controller is configured to return the vehicle height to an initial position when the controller determines that the back door is closed from an open state based on the information received from the back door open/close detector.

3. The vehicle height control system according to claim 1, wherein
the controller is configured to receive registration of user information, and
the controller is configured to, when a registered user is detected by the user detector, determine the vehicle height corresponding to the registered user based on the user information, and adjust the vehicle height according to a determination result.
